(19) United States
(12) Patent Application Publication
(10) Pub. No.: US 2024/0386794 A1
(43) Pub. Date: Nov. 21, 2024

(54) PREVENTIVE DEADLOCK CLASSIFIER

(71) Applicant: Volvo Autonomous Solutions AB, Göteborg (SE)

(72) Inventors: Åsa ROGENFELT, Gothenburg (SE); Jonas Hellgren, Göteborg (SE)

(73) Assignee: Volvo Autonomous Solutions AB, Göteborg (SE)

(21) Appl. No.: 18/638,083

(22) Filed: Apr. 17, 2024

(30) Foreign Application Priority Data
May 17, 2023 (EP) 23173944.2

(51) Int. Cl. G08G 1/01; G08G 1/0968

(52) U.S. Cl. CPC G08G 1/0133; G08G 1/0141; G08G 1/0145; G08G 1/096805

(57) ABSTRACT

A computer-implemented method of assessing vehicle trajectories for deadlock scenarios in a site where multiple vehicles operate by following planned vehicle trajectories is described. The site includes at least one traffic-constrained area via which at least two of the multiple vehicles passes when following their planned trajectories.

### TECHNICAL FIELD

The disclosure relates generally to design of sites where vehicles move in planned trajectories. In particular aspects, the disclosure relates to a preventive deadlock classifier. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

A traffic deadlock refers to a situation where vehicles or other modes of transportation are unable to move due to a network of roads or pathways becoming blocked or congested in a way that prevents any of them from moving forward. One example is when two vehicles meet in a narrow tunnel, where only one vehicle at a time can drive. As both vehicles wants access to the location of the other vehicle, the vehicles become stuck in a deadlock with only reversing out of the tunnel being possible. It is particularly a problem when planning trajectories for a plurality of heavy-duty vehicles as these vehicles can be more constrained than other types of vehicles in terms of how they move along a trajectory. When planning trajectories for a plurality of vehicles forming a vehicle fleet operating within a particular area or site, it is accordingly important to try to minimise the risk of deadlocks occurring as each vehicle will follow its planned trajectory even if this crosses a planned trajectory of another vehicle or passes through a traffic-constrained location where one or more other planned vehicle trajectories may pass.

Planning trajectories for autonomous or semi-autonomous heavy-duty vehicles operating in the same area can be particularly challenging as such vehicles may have a range of roles and operational tasks that use a motion support devices (MSDs) for their operation. MDSs may take the form of wide range of different physical devices, such as combustion engines, electric machines, friction brakes, regenerative brakes, shock absorbers, air bellows, and power steering pumps which may be individually controllable, for instance such that friction brakes may be applied at one wheel, i.e., a negative torque, while another wheel on the vehicle, perhaps even on the same wheel axle, is simultaneously used to generate a positive torque by means of an electric machine.

The operation of a heavy-duty vehicle is accordingly more complex than the operation of a more lightweight vehicle such as a car and extricating a plurality of heavy-duty vehicles from a deadlock situation may not be very straightforward, especially if the heavy-duty vehicle is operating autonomously. Even if a heavy-duty vehicle is semi-autonomously operated or manually driven or operated either from within the vehicle or remotely in some embodiments, if it encounters a deadlock along a guided trajectory it may require special skills and equipment as well as possibly reprogramming to be removed from the deadlock.

Reducing the likelihood of encountering a traffic deadlock is accordingly desirable when planning guided trajectories for a fleet of vehicles operating within the same area or site.

The disclosed technology seeks to mitigate, obviate, alleviate, or eliminate various issues known in the art that affect the ability of a vehicle to follow a guided trajectory in an area where traffic situations may include at least one area where vehicle occupancy is limited more than it is elsewhere along the vehicle trajectories.

### SUMMARY

According to a first aspect of the disclosure, a computer-implemented method of assessing vehicle trajectories for deadlock scenarios in a site where multiple vehicles operate by following planned vehicle trajectories, wherein the site includes at least one traffic-constrained area via which at least two of the multiple vehicles passes when following their planned trajectories, comprises:
generating a starting vehicle state for each of the multiple vehicles, the starting vehicle state of each vehicle corresponding to placing each vehicle at a start position on its planned trajectory, wherein each vehicle's planned trajectory in the site is represented using a connected directed graph of the site, and wherein the starting vehicle state is represented by a starting node of the connected directed graph,
iteratively updating the states of the multiple vehicles operating in the site from each vehicle's start position as the vehicles follow their planned trajectory, wherein with each iteration, for each vehicle: each vehicle's state is updated to a new vehicle state which indicates either:
the vehicle occupying another a further node along the connected directed graph to the node occupied by the vehicle in the previous iteration,
the vehicle occupying the node of the previous iteration; and
classifying, if the new vehicle state represents a current vehicle deadlock at the site, the new vehicle state as an explicit deadlock state,
storing the new vehicle state as an explicit deadlock state in a first classification memory,
classifying, if the new vehicle state represents a future vehicle deadlock at the site, the vehicle state as an implicit deadlock state; and
storing the new vehicle state as an implicit deadlock state in a second classification memory.

The first aspect of the disclosure may seek to provide a way to predict where deadlocks can happen at sites comprising at least one traffic-constrained area. A technical benefit may include that deadlocks can be avoided when designing and setting up such a site.

In some examples, including in at least one preferred example, optionally iteratively updating the states of the multiple vehicles comprises:
selecting the other node positions for the multiple vehicles randomly or pseudo-randomly with each iteration. A technical benefit may include the possibility to test a number of scenarios that may otherwise may have been overlooked if the node positions are selected systematically. A further technical benefit may be that it simplifies automation of the assessment of the vehicle trajectories for deadlock scenarios.

In some examples, including in at least one preferred example, optionally iteratively updating the states of the multiple vehicles comprises:
selecting the other node positions for the multiple vehicles to maximise their moved distance with each iteration. A technical benefit may include optimising the throughput of the site in order to maximise site productivity.

In some examples, including in at least one preferred example, optionally an explicit deadlock state fulfils the condition that a set of vehicles block each other from moving along their planned trajectories. A technical benefit may include that it is possible to easily recognise deadlock scenarios.

In some examples, including in at least one preferred example, optionally the vehicles are autonomous vehicles following planned trajectories.

In some examples, including in at least one preferred example, optionally the vehicles are manually operated vehicles following planned trajectories. The method is also applicable to a fleet of manually operated vehicles or a combination of the two. The manually operated vehicles can be remotely operated or driven by a driver.

In some examples, including in at least one preferred example, optionally the traffic-constrained area is a single traffic lane. Examples of such areas are gates, tunnels and similar areas that only a single vehicle can occupy.

In some examples, including in at least one preferred example, optionally the method comprises:
identifying the nodes along the vehicle trajectories, where the vehicles have the greatest likelihood of encountering traffic deadlock situations. A technical benefit may include that it makes it possible to adapt a site during the planning stage such that these nodes can be moved or deleted to remove the deadlock situations.

In some examples, including in at least one preferred example, optionally the method comprises:
Minimising the likelihood of deadlocks by adjusting one or more or all of: the number of vehicles; their vehicle trajectories; and one or more traffic constraint rules along the vehicle trajectories.

According to a second aspect of the disclosure, a computer-implemented traffic planner for planning a plurality of planned vehicle trajectories for vehicles within a site having at least one traffic-constrained location comprises:
a deadlock classifier model configured to classify a traffic situation for vehicle traffic following planned vehicle trajectories within the site, wherein the deadlock classifier comprises first classification memory and a second classification memory,
wherein the traffic planner is configured, based on classifications generated by the method according to the preceding claims, to populate the first classification memory with explicit deadlock states and the second classification memory with implicit deadlock states until all explicit and implicit deadlock states are found,
wherein the traffic planner is configured, based on the stored explicit and implicit deadlock states in the first classification memory and the second classification memory, to plan an action to perform along each planned vehicle trajectory in the site.

The second aspect of the disclosure may seek to provide a traffic planner that stores, in one or more memories, current (explicit) and future (implicit) deadlock states such that configuration of vehicle traffic at the site can be planned to avoid these states. A technical benefit may include configuring site traffic in advance of any vehicles being deployed. The planned vehicle trajectories by the traffic planner avoids problems such as vehicle jams, unnecessary delays or deadlocks.

In some examples, including in at least one preferred example, optionally the traffic planner is configured, based on the stored explicit and implicit deadlock states in the first and second classification memories, to determine if a planned design of a site where multiple vehicles will operate by following planned vehicle trajectories will cause implicit and/or explicit deadlocks. A technical benefit may include that the design of a site, before the site is constructed, can be seen to include deadlocks and can thereby be adapted to remove explicit and implicit deadlock states.

In some examples, including in at least one preferred example, optionally the traffic-constrained location within the site through which the plurality of planned vehicle trajectories pass, comprises a one-way section along which at least two vehicle trajectories pass in different directions.

In some examples, including in at least one preferred example, optionally the vehicles are autonomous or manually operated heavy-duty vehicles following predetermined planned vehicle trajectories in the site.

In some examples, including in at least one preferred example, optionally the site is a construction site, a mine, a harbour, a warehouse, an airport or a mass transit station.

According to a third aspect of the disclosure, a computer program product comprises program code for performing, when executed by the processing circuitry, the method of the first aspect of the disclosure.

According to a third aspect of the disclosure, a non-transitory computer-readable storage medium comprises instructions, which when executed by the processing circuitry, cause the processing circuitry to perform the method of the first aspect of the disclosure.

According to a fifth aspect of the disclosure, a method of configuring a site layout, wherein a plurality of heavy-duty vehicles follow planned trajectories between a plurality of site locations within the site comprises:
performing a method according to any one of method to determine if vehicle traffic comprising a plurality of vehicles following a plurality of predetermined vehicle trajectories in a site will lead to a vehicle deadlock; and if so,
modifying the site locations within the site until the predetermined vehicle trajectories do not lead to a deadlock.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognised by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is an exemplary design of a site comprising a traffic-constrained location.

FIG. 2 is an exemplary, simplified design of the site of FIG. 1, where vehicles within the site are in a deadlock state.

FIG. 3 is an exemplary, simplified design of the site of FIG. 1, where vehicles within the site are not in a deadlock state.

FIG. 4 shows a graph for the example site of FIG. 1, according to one example vehicle starting state for three vehicles.

FIG. 5 shows a simplified graph according to FIG. 4, after explicit deadlocks have been identified.

FIG. 6 shows the method according to the first aspect of the disclosure.

FIG. 7 shows an example of an apparatus including computer program code configured when executed to cause the apparatus to implement an embodiment of the method shown schematically in FIG. 6.

FIG. 8 is a schematic diagram of an exemplary computer system 800 for implementing examples disclosed herein.

### DETAILED DESCRIPTION

The detailed description set forth below provides information and examples of the disclosed technology with sufficient detail to enable those skilled in the art to practice the disclosure.

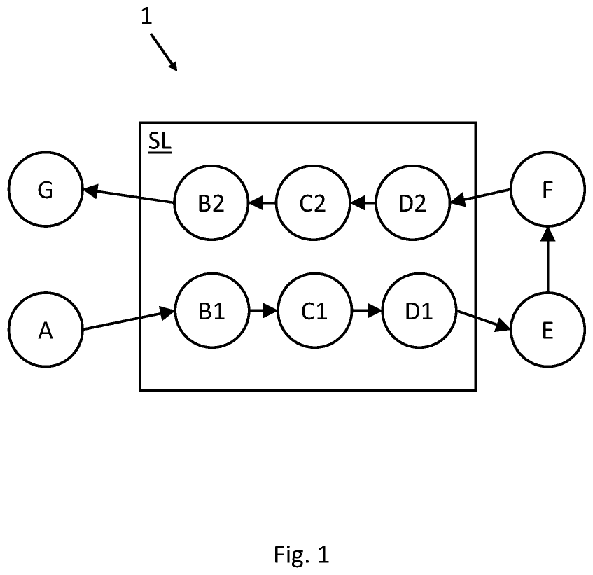

FIG. 1 is an exemplary design of a site 1 comprising a traffic-constrained area SL (for single lane, i.e. an area allowing only traffic going one-way at a time) where a plurality of vehicles follow planned vehicle trajectories around the site 1. In FIG. 1, the vehicle trajectory is cyclical and comprises nodes (in order of travel) A, B1, C1, D1, E, F, D2, C2, B2, G of which nodes B1, C1, D1, D2, C2 and B2 pass through the traffic-constrained area SL. The arrows indicate the intended direction of travel along the vehicle trajectories. In order to maintain an efficient flow in the site 1, each vehicle only travels in the direction of the arrow between the nodes and not in the opposite direction. The site 1 is thus modelled using a connected directed graph.

If the vehicle speeds are assumed to be constant along each vehicle trajectory, then the nodes will be located along each vehicle trajectory at equal time intervals or periods of time. If, however, a planned vehicle trajectory requires a vehicle to move more slowly along its trajectory within the site than other vehicles move along their trajectories, its nodes will be spaced closer together than the nodes along the other trajectories. Similarly, if a planned vehicle trajectory requires a vehicle to move more quickly along its trajectory path, then the nodes along that trajectory path will be spaced further apart as the vehicle will have moved more along its trajectory in that time period.

At a site where a number of vehicles will be guided autonomously or semi-autonomously along one or more planned trajectories, each vehicle's trajectory, meaning its direction along a path and speed of travel along that path, is ideally planned in advance using a traffic planner. The traffic planner, in other words, configures the site traffic in advance of any vehicles being deployed and guided along vehicle trajectories in a way that avoids any problems such as vehicle jams, unnecessary delays or deadlocks, where the trajectories planned result in a plurality of vehicles being unable to move because of the location they are in having certain traffic constraints on vehicle occupancy limits in that location. In the site 1, this location is the traffic-constrained area SL.

In the traffic-constrained area SL, only one vehicle may drive through at a time. In practice, this means that if one of the nodes B1, C1, D1, D2, C2 and B2 is occupied, all nodes B1, C1, D1, D2, C2 and B2 are considered occupied for the sake of determining deadlock or not even though a vehicle at for example B1 can move to C1 and D1 before encountering another vehicle in front of it.

A traffic deadlock is a traffic “impasse” situation that may occur along or at the destination or start of a vehicle trajectory in a traffic-constrained area. A traffic-constrained area is an area where node occupancy is restricted. The occupancy restriction may be for a number of nodes that are on the same vehicle trajectory or for nodes on different vehicle trajectories.

Other examples of traffic-constrained areas include contraflow-type situations or any similar location along a trajectory where there is a narrowing in the road surface along a vehicle trajectory where vehicles have to pass each other in single file. A traffic-constrained area may also be created by a task that a vehicle has to perform at a particular location along its trajectory. For example, lack of access to an available loading bay or a refuelling point along a trajectory may also create a deadlock situation, if a vehicle occupying such a location cannot vacate the location because another vehicle is occupying the next available location along its trajectory.

A deadlock situation may occur when two or more nodes in a traffic-constrained area enter a cyclic state of occupancy such that a first node within the traffic-constrained location cannot be vacated until another node in the traffic-constrained location has been vacated, where the other node in the traffic-constrained location cannot be vacated until the first node has been vacated. A deadlock can accordingly occur where multiple vehicles are all following the same trajectory path but are occupying different nodes along that trajectory path or amongst multiple vehicles each following different trajectories/trajectory paths that enter a traffic-constrained area from different directions.

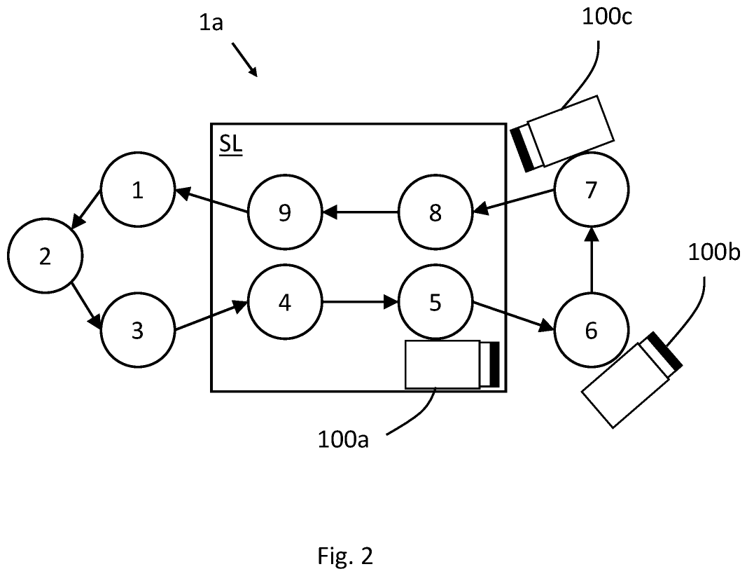

FIG. 2 is an exemplary, simplified site 1a of the site 1 of FIG. 1, where a fleet of vehicles 100a, 100b, 100c follow their planned trajectories around the site 1a. The site 1a comprises a cyclical vehicle trajectory comprising of nodes 1-9, where a traffic-constrained area comprises nodes 4, 5, 8 and 9. The vehicle trajectories include moving through nodes 1-9 in numerical order. Similar as for FIG. 1, if a vehicle occupies one of the nodes 4, 5, 8 and 9, none of the other nodes 4, 5, 8 and 9 are available to move to for another vehicle. FIG. 2 shows how a traffic deadlock occurs as the plurality of vehicles 100a, 100b, 100c move along the single vehicle trajectory that passes more than once through the traffic-constrained area SL. As shown in FIG. 2, vehicle 100a at node 5 cannot move in the next time period to node 6 as vehicle 100b is occupying node 6 and cannot move as its next node would be 7 which is occupied by vehicle 100c which cannot move into the traffic-constrained area SL node 8 due to vehicle 100a occupying node 5 of the traffic-constrained area SL already.

The movement of the vehicles 100a-c along their planned trajectories is in some embodiments fully autonomous, in other words, their speed, direction of travel, and the path of the vehicle trajectories are all determined by a traffic planner for the site. Nonetheless, in some embodiments, despite the traffic planner configuring vehicle trajectories to guide the vehicles along their trajectory paths, the vehicle may be manually controlled for some tasks and in some embodiments the vehicles may be guided semi-autonomously and/or remotely, for example, from a site server or back office server in a manner which allows them to follow a planned trajectory.

At a site where a number of vehicles will be guided autonomously or semi-autonomously along one or more planned trajectories, each vehicle's trajectory, meaning its direction along a path and speed of travel along that path, is ideally planned in advance using the traffic planner. The traffic planner in other words, configures the site traffic in advance of any vehicles being deployed and guided along vehicle trajectories in a way that avoids any problems such as vehicle jams, unnecessary delays or deadlocks, where the trajectories planned result in a plurality of vehicles being unable to move because of the location they are in having certain traffic constraints on vehicle occupancy limits in that location.

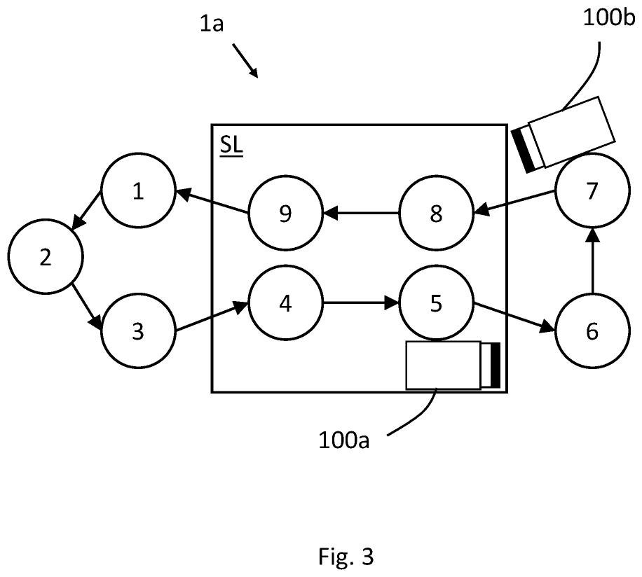

FIG. 3 is an exemplary of the simplified site 1a of the site 1 of FIG. 1, where vehicles within the site 1a are not in a deadlock state. FIG. 3, in contrast to FIG. 2, illustrates schematically how reducing the number of vehicles travelling along the trajectory shown in FIG. 2 to just two vehicles, 100a and 100b separated by at least one node, could not result in a deadlock situation, as one vehicle will never block the other vehicle from entering the constrained area or leaving it when following the guided trajectory as shown when there is at least one nodes distance between them. The vehicle 100b at node 7 can move to node 8 when the vehicle 100a at node 5 moves to node 6. In other words, by changing the number and/or spacing of vehicles following a guided trajectory a gridlock situation may be avoided. Spacing between vehicles following the same trajectory path can be achieved by changing their relative speeds between nodes and/or having one vehicle wait at a node, for example, by being modelled to occupy a node for a plurality of time intervals or periods. Further, minimising the likelihood of deadlocks can be made by adjusting the number of vehicles; their vehicle trajectories; and/or one or more traffic constraint rules along the vehicle trajectories. Traffic constraint rules can for instance be to make a planned single lane area of the trajectory into a two-lane area or to setup additional nodes that can be included in the planned trajectory to bypass the traffic-constrained area.

The node positions that each of the multiple vehicles occupy are randomly or pseudo-randomly selected with each iteration. This means that each vehicle randomly or pseudo-randomly either moves to a node further along the trajectory or waits at the node it is currently at. Alternatively, the node positions for the multiple vehicles are selected to maximise their moved distance for each time period.

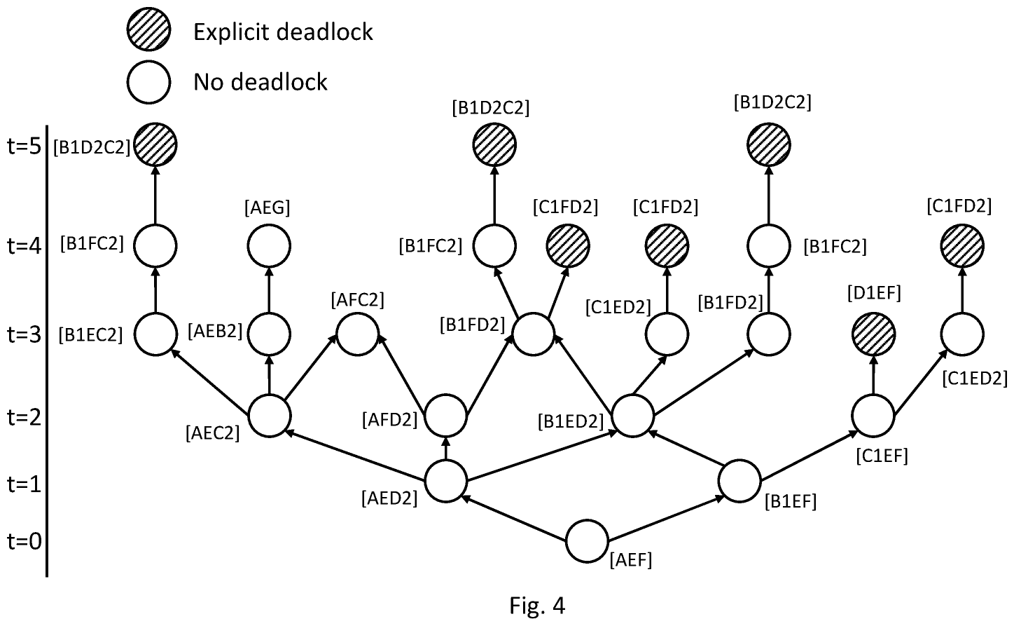

FIG. 4 shows a deadlock graph or search tree for the example site of FIG. 1, according to one example vehicle starting state for three vehicles. When designing and setting up site where vehicles will move along planned trajectories, it is desired to avoid deadlock in order to reduce downtime due to that vehicles need to be backed out of deadlocks or that vehicle will have to wait excessive amounts of time in certain places. Referring to FIG. 1, if three vehicles are positioned in nodes D1, E and F there is a current deadlock situation, this is also called an explicit deadlock. None of the vehicles can move.

If the vehicles instead would be placed at nodes B1, E, F, the three vehicles are not currently in a deadlock and can move as the vehicle in B1 can move to C1 and D1, but any possible steps taken by any of the vehicles will lead to a future deadlock. Such a situation is called an implicit deadlock.

Referring again to FIG. 1, an example starting point for a calculation of implicit (or future) or explicit (or current) deadlocks, is set to be nodes A, E and F. This is indicated in the figure as the state [AEF]. This state is set at time t=0.

At time t=1, one of the vehicles move to a node further along the trajectory and the state is evaluated for deadlock or no deadlock. A classifier informs the search tree of a state is an explicit deadlock or not. An example of such a deadlock classifier model can be found in the patent application EP22196693.0 from the same applicant. As can be seen, the states [AED2] and [B1EF] does not constitute an explicit deadlock, but [B1EF] eventually will lead to an explicit deadlock and is thereby an implicit deadlock.

At time t=2, one of the vehicles of each previous state move to a node further along the trajectory and the new state is evaluated for deadlock or no deadlock. Also, at this stage, no one of the states [AEC2], [AFD2], [B1ED2] or [C1EF] constitutes an explicit deadlock.

At time t=3, one of the vehicles of each previous state move to a node further along the trajectory and the new state is evaluated for deadlock or no deadlock. Here, the first explicit deadlock is encountered at state [D1EF]. In these positions, none of the three vehicles can move since the vehicle in D1 needs to move to E, which is occupied, the vehicle in E needs to move to F, which is occupied and the vehicle in F needs to move to D2, which is occupied as this is part of the traffic-constrained area comprising nodes B1, C1, D1, D2, C2, B2. From this state, the calculation stops. The remaining states [B1EC2], [AEB2], [AFC2], [B1FD2] or [C1ED2] does not constitute an explicit deadlock. From these states, the calculation continues. Note that states occur at several branches of the graph as time progresses.

At time t=4, a further state constituting explicit deadlock has been identified: [C1FD2]. One state, [AEG], where one of the vehicles has reached the end node G has been arrived at which does not constitute a deadlock.

At time t=5, the final state constituting explicit deadlock, [B1D2C2] has been reached and further calculations are stopped. For larger sites with more vehicles involve, additional time steps may be required in order to calculate all explicit deadlocks.

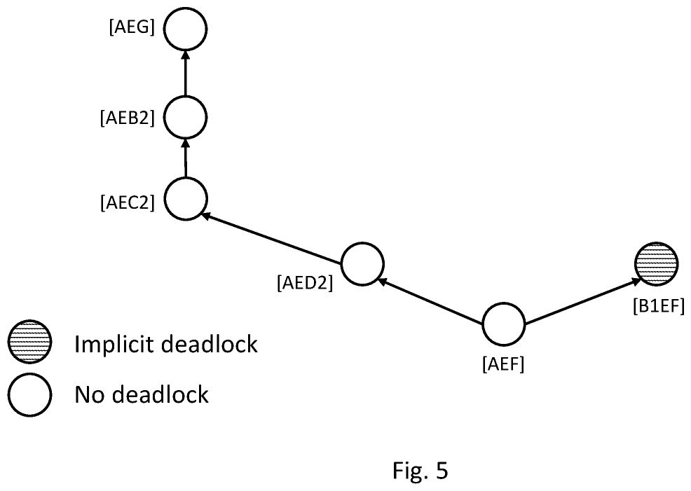

FIG. 5 shows a simplified graph or search tree according to FIG. 4, after all explicit deadlocks for the starting position [AEF] have been identified. After all explicit deadlocks have been identified as shown in FIG. 4, the graph or search tree can be simplified or pruned to only contain the states that will not lead to a deadlock as well as the first state that will ultimately lead to explicit deadlocks, i.e. a state with implicit deadlock is shown, in this example the state [C1EF]. Thus, moving the vehicle starting in node A to node B as the first step will ultimately lead to an explicit deadlock.

Once the calculations for all states with explicit deadlock have been made for all starting positions of the vehicles, as the example of figure shows, simplified graphs or search trees can be stored that will in very short time show the states that does not lead to deadlock. This simplification of complex calculations that are made offline will save a lot of time during planning of a worksite and can also be used in real-time to adapt a vehicle trajectory if needed.

By calculating which vehicle moves result in a trajectory that will cause them to end up in a deadlock using the calculations as shown above, vehicle trajectories can be more reliably identified offline, which when implemented reduce the likelihood of or completely avoid subsequent deadlocks. Advantageously, this allows the traffic planner to select actions to guide a set of vehicles along vehicle trajectories and/or to plan for a number of vehicles to follow the same trajectory whilst observing node occupancy constraints in a way that reduces reduce the likelihood of a deadlock occurring along any traffic-constrained areas long their trajectory/trajectories.

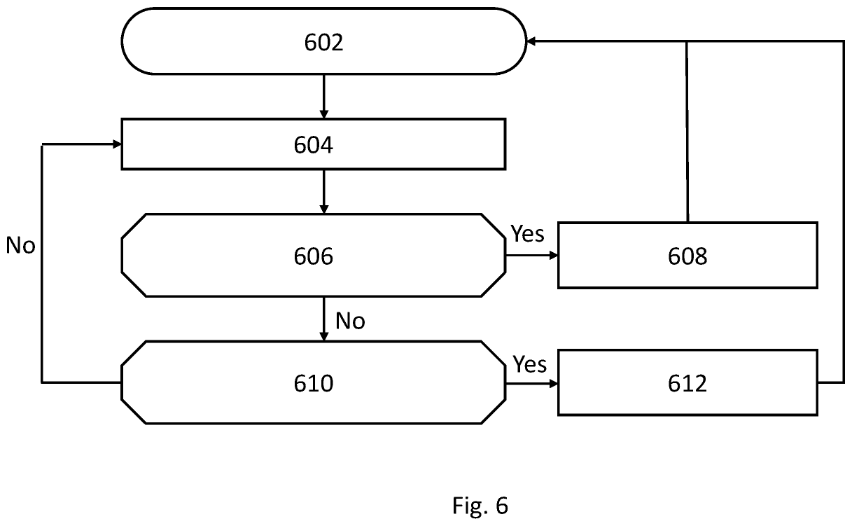

FIG. 6 is a flowchart of an exemplary method 600 of assessing vehicle trajectories for deadlock scenarios in a site where multiple vehicles operate by following planned vehicle trajectories. The method 600 may comprise the following actions, steps or operations.

Action 602. The vehicles for which the calculation of deadlock states are to be made are placed at their respective start nodes. As described in conjunction with FIG. 4 above, planning for three vehicles to move along the trajectory of the site of FIG. 1, the starting nodes are nodes A, E and F respectively. Action 604. One or more of the vehicles are moved along their planned vehicle trajectory to a new state corresponding to positioning at least one vehicle at a node further along the trajectory. This corresponds to one of the states at time t=1 of FIG. 4. Action 606. The new state, i.e. new vehicle positions, is checked to see if it constitutes an explicit deadlock or not. Action 608. If the new state is determined to constitute an explicit deadlock, the state is added to a first classification memory M_1. The vehicles are reset to new start locations for a new calculation. Action 610. If the state checked during Action 606 is not deemed to be an explicit deadlock, the state is checked to see if it constitutes an implicit deadlock, i.e. a state that no matter how the vehicles move after moving to that state will lead only to future explicit deadlocks. If the new state is not deemed to constitute an implicit deadlock, one or more of the vehicles move again according to Action 604. This corresponds to a state at time t=2. Action 612. If the state is determined to constitute an implicit deadlock, the state is added to a second classification memory M_2. The vehicles are reset to new start locations for a new calculation.

Calculations according to the above are made until all explicit and implicit deadlocks are found for all starting positions. This builds up several graphs of FIG. 4 that in turn can be simplified to graphs according to FIG. 5.

The first and second classification memories, M_1 and M_2 may be different parts of the same memory or may be two separate memories that can be accessed by the computer-implemented traffic planner.

As an example, the table below presents an example applying the method of the disclosure to site 1 of FIG. 1:

TABLE 1
Example application of the method of the disclosure.

| | Found | | Number of | Number of | |
|---|---|---|---|---|---|
| Iteration | deadlock | Type | items in M_1 | items in M_2 | Comment |
| 1 | E, F, D1 | Explicit | 1 | 0 | |
| 2 | E, F, C1 | Implicit | 1 | 1 | At this state vehicle at F is |
| | | | | | not allowed to move due |
| | | | | | to the single lane of the |
| | | | | | traffic-constrained area. |
| | | | | | The only possible move of |
| | | | | | the vehicle at C1 will result |
| | | | | | into the explicit deadlock |
| | | | | | found in iteration 1. |
| 3 | E, F, D1 | Implicit | 1 | 2 | Similar situation as above |
| | | | | | but the implicit deadlock |
| | | | | | found in iteration 2 blocks |
| | | | | | future movement of the |
| | | | | | vehicles. |

When the process is finished, the memories will contain states according to the table below:

| | |
|---|---|
| M_1: | E, F, D1 |
| M_2: | [E, F, C1], [E, F, B1] |

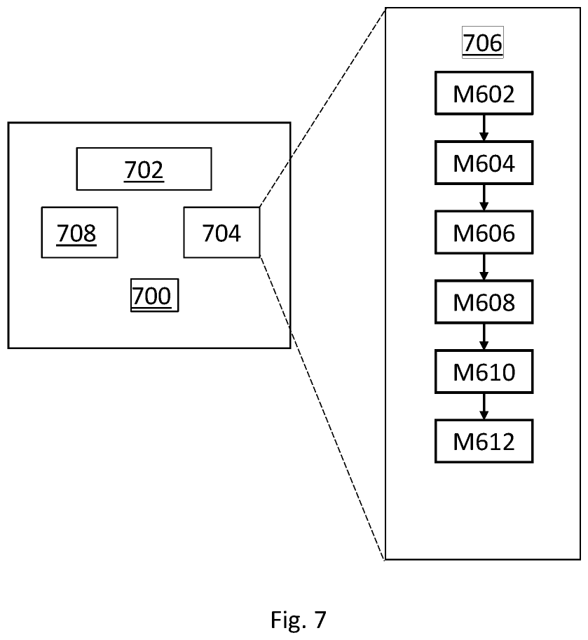

FIG. 7 shows an example of a traffic planner 700 including computer program code configured when executed to cause the traffic planner to implement the method shown schematically in FIG. 6. The traffic planner 700 further comprises a memory 704, computer code 706 and one or more processor(s) or processing circuitry 708. The computer code, when loaded from memory 704 and executed by the one or more processors or processing circuitry 708, causes the traffic planner 700 to perform the actions, steps or operations of the methods described above. Also, the memory 704 may comprise the first and second classification memories, M_1 and M_2. Alternatively, the first and second classification memories, M_1 and M_2 may be one or two separate memories of the traffic planner 700.

One or more data communication component(s) 702 may be provided for the traffic planner to enable communications with one or more remote entities. For example, in some embodiments a suitable receiver/transmitter/antenna arrangement is provided to communicate planned vehicle trajectories with one or more vehicles 100a-100c which form a planned fleet of vehicles intended to operate at a particular site or which are operating at a particular site to update the vehicles' planned vehicle trajectories at the site or defined region. The one or more data communication component(s) 702 may also be used to provide an alert when a deadlock has been identified by the method 600.

The memory 702 stores computer program code 706 which, when loaded from the memory and executed by the one or more processor(s) or processing circuitry configures the traffic planner 700 to perform the disclosed method 600 for example. For example, in the embodiment of the computer program code shown in FIG. 7, the computer program code 706 comprises a set of computer code modules M602-M612, which correspond to steps S602 to S612 shown in FIG. 6.

The computer-implemented traffic planner is configured for planning a plurality of planned vehicle trajectories for vehicles within a site according the examples above having at least one traffic-constrained area according the examples above. The traffic planner comprises a deadlock classifier model configured to classify a traffic situation for vehicle traffic following planned vehicle trajectories within the site. An example of such a deadlock classifier model can be found in the patent application EP22196693.0 from the same applicant. The deadlock classifier comprises first classification memory and a second classification memory wherein the traffic planner is configured, based on classifications generated by the method according to FIG. 6, to populate the first classification memory with explicit deadlock states and the second classification memory with implicit deadlock states until all explicit and implicit deadlock states are found. The traffic planner is further configured, based on the stored explicit and implicit deadlock states in the first classification memory and the second classification memory, to plan an action to perform along each planned vehicle trajectory in the site. The action can for instance be for a vehicle to remain at the current node to give way to another vehicle or to move the vehicle forward to the next node. These are only two examples that can be used as actions. It would also be possible to expand the actions to several vehicles at once such as stopping several vehicles to give way to one or more vehicles or to move several vehicles to their respective next nodes. It is also possible to increase and decrease the speed of each vehicle between nodes to optimise the flow of traffic.

The traffic planner may further be configured, based on the stored explicit and implicit deadlock states in the first and second classification memories, to determine if a planned design of a site where multiple vehicles will operate by following planned vehicle trajectories will cause implicit and/or explicit deadlocks. In this way, vehicle trajectories for the site can already during planning to a great extent be laid out such that the risk of encountering deadlocks are removed or at least greatly reduced. Should the site need to be adapted over time, such as for instance due to a new phase in construction or due to expansion of a site such as a mine, harbour or warehouse, the traffic flow can already be planned in order for traffic to flow smoothly as soon as the adaptation of the site is finished.

The traffic planner may be implemented on a stand-alone server or server system. The traffic planner is configured to assess a plurality of vehicle trajectories where a vehicle trajectory comprises a trajectory path, direction of travel, and action along the trajectory path in the direction of travel, for example, an action to pause at a particular segment of the trajectory, or to move to the next segment along the trajectory. A traffic planner for a site accordingly has the objective of planning how a plurality of vehicles should move or be guided along one or more trajectory paths in a site or similar defined area or region. Ideally, the guided vehicle trajectories at a site are planned in a way that avoids deadlocks occurring to maximise their individual or fleet efficiency. For example, vehicle trajectories that avoid deadlocks may allow vehicles at a site to function in a way that optimises their operational behaviour and fuel consumption, and ideally so that the site of operations as a whole is run efficiently.

The traffic planner can calculate for each vehicle a vehicle trajectory that avoids a deadlock occurring within the planning horizon. In this way, the traffic planner may configure a plurality of vehicle trajectories within a site or similarly defined area where there may be one or more traffic-constrained areas or locations. The traffic planner may optimize the efficiency of the vehicle movements within the site to improve vehicle-related operations. For example, congestion at loading or unloading locations or at fuelling sites can be avoided.

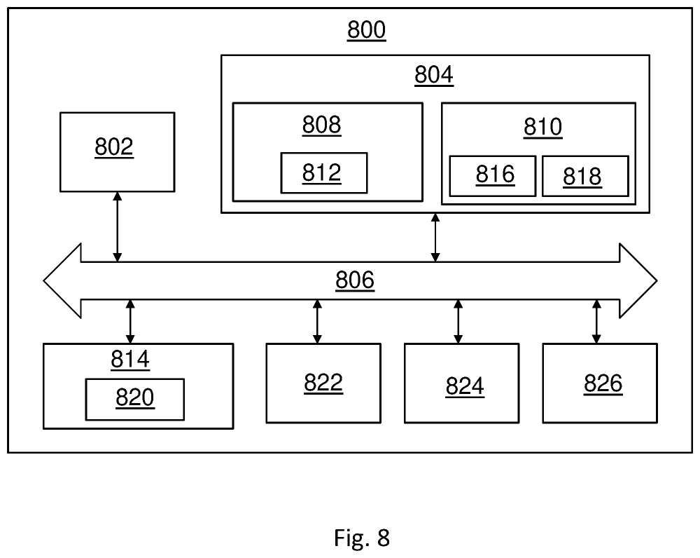

FIG. 8 is a schematic diagram of a computer system 800 for implementing examples disclosed herein. The computer system 800 is adapted to execute instructions from a computer-readable medium to perform these and/or any of the functions or processing described herein. The computer system 800 may be connected (e.g., networked) to other machines in a LAN, an intranet, an extranet, or the Internet. While only a single device is illustrated, the computer system 800 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 800 may comprise at least one computing device or electronic device capable of including firmware, hardware, and/or executing software instructions to implement the functionality described herein. The computer system 800 may include processing circuitry 802 (e.g., processing circuitry including one or more processor devices or control units), a memory 804, and a system bus 806. The computer system 800 may include at least one computing device having the processing circuitry 802. The system bus 806 provides an interface for system components including, but not limited to, the memory 804 and the processing circuitry 802. The processing circuitry 802 may include any number of hardware components for conducting data or signal processing or for executing computer code stored in memory 804. The processing circuitry 802 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 802 may further include computer executable code that controls operation of the programmable device.

The system bus 806 may be any of several types of bus structures that may further interconnect to a memory bus (with or without a memory controller), a peripheral bus, and/or a local bus using any of a variety of bus architectures. The memory 804 may be one or more devices for storing data and/or computer code for completing or facilitating methods described herein. The memory 804 may include database components, object code components, script components, or other types of information structure for supporting the various activities herein. Any distributed or local memory device may be utilised with the systems and methods of this description. The memory 804 may be communicably connected to the processing circuitry 802 (e.g., via a circuit or any other wired, wireless, or network connection) and may include computer code for executing one or more processes described herein. The memory 804 may include non-volatile memory 808 (e.g., read-only memory (ROM), erasable programmable read-only memory (EPROM), electrically erasable programmable read-only memory (EEPROM), etc.), and volatile memory 810 (e.g., random-access memory (RAM)), or any other medium which can be used to carry or store desired program code in the form of machine-executable instructions or data structures and which can be accessed by a computer or other machine with processing circuitry 802. A basic input/output system (BIOS) 812 may be stored in the non-volatile memory 808 and can include the basic routines that help to transfer information between elements within the computer system 800.

The computer system 800 may further include or be coupled to a non-transitory computer-readable storage medium such as the storage device 814, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 814 and other drives associated with computer-readable media and computer-usable media may provide non-volatile storage of data, data structures, computer-executable instructions, and the like.

Computer-code that is hard or soft coded may be provided in the form of one or more modules. The module(s) can be implemented as software and/or hard-coded in circuitry to implement the functionality described herein in whole or in part. The modules may be stored in the storage device 814 and/or in the volatile memory 810, which may include an operating system 816 and/or one or more program modules 818. All or a portion of the examples disclosed herein may be implemented as a computer program 820 stored on a transitory or non-transitory computer-usable or computer-readable storage medium (e.g., single medium or multiple media), such as the storage device 814, which includes complex programming instructions (e.g., complex computer-readable program code) to cause the processing circuitry 802 to carry out actions described herein. Thus, the computer-readable program code of the computer program 820 can comprise software instructions for implementing the functionality of the examples described herein when executed by the processing circuitry 802. In some examples, the storage device 814 may be a computer program product (e.g., readable storage medium) storing the computer program 820 thereon, where at least a portion of a computer program 820 may be loadable (e.g., into a processor) for implementing the functionality of the examples described herein when executed by the processing circuitry 802. The processing circuitry 802 may serve as a controller or control system for the computer system 800 that is to implement the functionality described herein.

The computer system 800 may include an input device interface 822 configured to receive input and selections to be communicated to the computer system 800 when executing instructions, such as from a keyboard, mouse, touch-sensitive surface, etc. Such input devices may be connected to the processing circuitry 802 through the input device interface 822 coupled to the system bus 806 but can be connected through other interfaces, such as a parallel port, an Institute of Electrical and Electronic Engineers (IEEE) 1394 serial port, a Universal Serial Bus (USB) port, an IR interface, and the like. The computer system 800 may include an output device interface 824 configured to forward output, such as to a display, a video display unit (e.g., a liquid crystal display (LCD) or a cathode ray tube (CRT)). The computer system 800 may include a communications interface 826 suitable for communicating with a network as appropriate or desired.

According to the disclosed technology, vehicle trajectories within a site are modelled and assessed to see if they will lead to a traffic deadlock at the site. The classification of each of the vehicle trajectories is made offline in a computer model of the site of interest and the output of the classifier is made available to the traffic planner when a candidate vehicle trajectory is being assessed by the traffic planner. However, in some embodiments, the traffic planner may also respond dynamically to traffic situations as they occur on the site of interest, and it is possible in some embodiments to use the traffic planner to adjust vehicle trajectories in real-time by drawing on a set of guided vehicle trajectories that have been generated in advance and classified for that site as leading to a potential deadlock or not. This may allow dynamic adjustment of guided trajectories for one or more vehicles at a site in some embodiments.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

Example 1: A computer-implemented traffic planner according to the second aspect, wherein the vehicles are autonomous or manually operated heavy-duty vehicles following predetermined planned vehicle trajectories in the site.

Example 2: A computer-implemented traffic planner according to the second aspect, wherein the site being a construction site, a mine, a harbour, a warehouse, an airport or a mass transit station.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealised or overly formal sense unless expressly so defined herein.

It is to be understood that the present disclosure is not limited to the aspects described above and illustrated in the drawings; rather, the skilled person will recognise that many changes and modifications may be made within the scope of the present disclosure and appended claims. In the drawings and specification, there have been disclosed aspects for purposes of illustration only and not for purposes of limitation, the scope of the disclosure being set forth in the following claims.

1. A computer-implemented method of assessing vehicle trajectories for deadlock scenarios in a site where multiple vehicles operate by following planned vehicle trajectories, wherein the site includes at least one traffic-constrained area via which at least two of the multiple vehicles passes when following their planned trajectories, the method comprising:
generating a starting vehicle state for each of the multiple vehicles, the starting vehicle state of each vehicle corresponding to placing each vehicle at a start position on its planned trajectory, wherein each vehicle's planned trajectory in the site is represented using a connected directed graph of the site, and wherein the starting vehicle state is represented by a starting node of the connected directed graph,
iteratively updating the states of the multiple vehicles operating in the site from each vehicle's start position as the vehicles follow their planned trajectory, wherein with each iteration, for each vehicle: each vehicle's state is updated to a new vehicle state which indicates either:
the vehicle occupying another a further node along the connected directed graph to the node occupied by the vehicle in the previous iteration,
the vehicle occupying the node of the previous iteration; and
classifying, if the new vehicle state represents a current vehicle deadlock at the site, the new vehicle state as an explicit deadlock state,
storing the new vehicle state as an explicit deadlock state in a first classification memory,
classifying, if the new vehicle state represents a future vehicle deadlock at the site, the vehicle state as an implicit deadlock state; and
storing the new vehicle state as an implicit deadlock state in a second classification memory.

2. A computer-implemented method according to claim 1, wherein iteratively updating the states of the multiple vehicles comprises:
selecting the other node positions for the multiple vehicles randomly or pseudo-randomly with each iteration.

3. A computer-implemented method according to claim 1, wherein iteratively updating the states of the multiple vehicles comprises:
selecting the other node positions for the multiple vehicles to maximise their moved distance with each iteration.

4. A computer-implemented method according to claim 1, wherein an explicit deadlock state fulfils the condition that a set of vehicles block each other from moving along their planned trajectories.

5. A computer-implemented method according to claim 1, wherein the vehicles are autonomous vehicles following planned trajectories.

6. A computer-implemented method according to claim 1, wherein the vehicles are manually operated vehicles following planned trajectories.

7. A computer-implemented method according to claim 1, wherein the traffic-constrained area is a single traffic lane.

8. A computer-implemented method according to claim 1, wherein the method comprises:
identifying the nodes along the vehicle trajectories, where the vehicles have the greatest likelihood of encountering traffic deadlock situations.

9. A computer-implemented method according to claim 1, wherein the method comprises:
minimising the likelihood of deadlocks by adjusting one or more or all of: the number of vehicles; their vehicle trajectories; and one or more traffic constraint rules along the vehicle trajectories.

10. A computer-implemented traffic planner for planning a plurality of planned vehicle trajectories for vehicles within a site having at least one traffic-constrained location, the traffic planner comprising:
a deadlock classifier model configured to classify a traffic situation for vehicle traffic following planned vehicle trajectories within the site, wherein the deadlock classifier comprises first classification memory and a second classification memory,
wherein the traffic planner is configured, based on classifications generated by the method according to claim 1, to populate the first classification memory with explicit deadlock states and the second classification memory with implicit deadlock states until all explicit and implicit deadlock states are found,
wherein the traffic planner is configured, based on the stored explicit and implicit deadlock states in the first classification memory and the second classification memory, to plan an action to perform along each planned vehicle trajectory in the site.

11. A computer-implemented traffic planner according to claim 10, wherein the traffic planner is configured, based on the stored explicit and implicit deadlock states in the first and second classification memories, to determine if a planned design of a site where multiple vehicles will operate by following planned vehicle trajectories will cause implicit and/or explicit deadlocks.

12. A computer-implemented traffic planner of claim 10, wherein the traffic-constrained location within the site through which the plurality of planned vehicle trajectories pass, comprises a one-way section along which at least two vehicle trajectories pass in different directions.

13. A computer program product comprising program code for performing, when executed by the processing circuitry, the method of claim 1.

14. A non-transitory computer-readable storage medium comprising instructions, which when executed by the processing circuitry, cause the processing circuitry to perform the method of claim 1.

15. A method of configuring a site layout, wherein a plurality of heavy-duty vehicles follow planned trajectories between a plurality of locations within the site, the method comprising:
performing a method according to claim 1 to determine if vehicle traffic comprising a plurality of vehicles following a plurality of predetermined vehicle trajectories in a site will lead to a vehicle deadlock; and if so,
modifying the locations on the site until the predetermined vehicle trajectories do not lead to a deadlock.
